(19) United States
(12) Patent Application Publication
(10) Pub. No.: US 2010/0032107 A1
(43) Pub. Date: Feb. 11, 2010

(54) ENCLOSURE ASSEMBLY

(75) Inventors: James C. Schumacher, Royal Oak, MI (US); Tracy E. Roberts, Shelby Township, MI (US); James R. Cosgrove, Woodhaven, MI (US); Robert T. Cosgrove, II, Trenton, MI (US)

Correspondence Address: HARNESS, DICKEY & PIERCE, P.L.C., P.O. BOX 828, BLOOMFIELD HILLS, MI, 48303, US

(73) Assignee: Gallagher-Kaiser Corporation, Detroit, MI (US)

(21) Appl. No.: 12/496,778

(22) Filed: Jul. 2, 2009

Related U.S. Application Data
(60) Provisional application No. 61/078,191, filed on Jul. 3, 2008.

(51) Int. Cl. A47H 1/18; E06B 1/52; B23P 11/00

(52) U.S. Cl. 160/181; 160/330; 52/204.1; 29/428

(57) ABSTRACT

An environmentally controlled enclosure having a cable system that supports a curtain. The use of a cable system to support curtain reduces the cost to manufacture the environmentally controlled enclosure. In this regard, rather than producing an enclosure system substantially formed of steel beams, the cable system requires only a frame formed to support the cable system. The reduction in steel used to form enclosures reduces the overall cost to manufacture the enclosure. Moreover, the cable system is relatively simple in design, which reduces the time to manufacture and set up enclosure.

### CROSS-REFERENCE TO RELATED APPLICATIONS

This application claims the benefit of U.S. Provisional Application No. 61/078,191, filed on Jul. 3, 2008. The entire disclosure of the above application is incorporated herein by reference.

### FIELD

The present disclosure relates to an enclosure utilizing a cable system to suspend a plastic curtain.

### BACKGROUND

The statements in this section are intended to provide background information related to the present disclosure and may not constitute prior art.

During a manufacturing process it is often necessary to convey or transfer parts between various stations to perform operations. It may be necessary to isolate the part from the environment within the plant depending on the condition of the part during transportation. For example, during an automotive painting process, a vehicle body is transferred from a spray booth to a curing station. Transferring the vehicle body in the open environment of the assembly plant may contaminate the exterior finish of the vehicle body with dust, moisture or other debris and result in an unacceptable finish. Environmentally controlled enclosures have been used to isolate manufactured parts from the environment within the manufacturing plant.

Some environmentally control enclosures are composed of structures which support plastic sheeting or panels that assist in controlling the environment therein, as well as enable workers in the plant to view the vehicle as it travels therethrough. U.S. Pat. Nos. 4,86,778 and 5,224,306 to Pohl and Cramer, respectively, for example, disclose enclosures made from a plurality U-shaped struts with plastic panels secured to the strut by a cap positioned in the strut. The enclosure described herein is intended as an alternate structure to those described in the foregoing patents and as further described herein can be used in place of or in combination with such enclosures.

### SUMMARY

The present disclosure provides an environmentally controlled enclosure having a cable system that supports a curtain defining the enclosed volume. The use of a cable system to interconnect frame members and suspend a sheeting assembly reduces the cost to manufacture the environmentally controlled enclosure. In this regard, rather than assembling an enclosure system substantially formed of steel beams, the cable system requires only a series of frame members formed to support the cable system. The cable system suspends the sheeting assembly, thereby reducing the number of beams or struts needed to construct the enclosure. The reduction in beams used to form enclosures reduces the overall cost to manufacture the enclosure. Moreover, the cable system is relatively simple in design, which reduces the time to manufacture and set up enclosure.

In addition, the curtain may be formed of either a plurality of panels or sheeting that may be formed of a plastic that does not burn, but rather melts if subjected to an abnormally high temperature. Because the curtain may melt rather than burn, no hazardous or noxious fumes will be released. Such a feature enables the omission of sprinklers within the enclosure which further reduces the cost to manufacture, maintain, and erect the enclosure.

Further areas of applicability will become apparent from the description provided herein. It should be understood that the description illustrations and embodiments are intended for purposes of illustration only and are not intended to limit the scope of the present disclosure.

### DRAWINGS

FIG. 1 is a plan view of an environmentally controlled enclosure system according to the present disclosure in a manufacturing plant;

FIG. 2 is a side elevation of a portion of the enclosure system called out at II-II shown in FIG. 1;

FIG. 3 is a cross-section taken through the environmentally controlled enclosures called out at III-III in FIG. 2;

FIG. 4 is a detail of a connection between a pair of support members that frame the environmentally controlled enclosure illustrated in FIG. 3;

FIG. 5 is a detail of the roof suspension mechanism that supports a roof panel portion of the environmentally controlled enclosure illustrated in FIG. 3;

FIG. 6 is a detail of a roof panel having a hem formed with a double-sided tape;

FIG. 7 is a detail similar to FIG. 6 in which a grommet extends through the hem;

FIG. 8 is a detail of the suspension mechanism that supports a roof panel portion and a wall panel portion of the environmentally controlled enclosure illustrated in FIG. 3;

FIG. 9 is a detail of the anchoring mechanism that supports a wall panel portion of the environmentally controlled enclosure illustrated in FIG. 3;

FIG. 10 is a cross-section of another environmentally controlled enclosure that may be assembled according to the present disclosure;

FIG. 11 is a detail of a pair of suspension mechanisms that supports a roof panel portion of the environmentally controlled enclosure illustrated in FIG. 10;

FIG. 12 is a detail similar to FIG. 8 in which a roof panel portion and a side wall panel portion are supported by a suspension cable;

FIG. 13 is a detail similar to FIG. 12 in which a roof panel portion is supported by a first cable and a side wall panel portion is supported by a second cable;

FIG. 14 is a detail showing an upper roof panel portion supported by a cable and having a skirt extending down to a lower roof panel portion;

FIG. 15 is a side elevation showing an access opening formed through the side wall panel of the enclosure illustrated in FIG. 2;

FIG. 16 is a vertical cross-section view of the access opening shown in FIG. 15;

FIG. 17 is a horizontal cross-section of the access opening shown in FIG. 15;

FIG. 18 is a side elevation showing a door opening formed through the side wall panel of the enclosure illustrated in FIG. 2;

FIG. 19 is a vertical cross-section of the door opening shown in FIG. 18;

FIG. 20 is a horizontal cross-section of the door opening shown in FIG. 18;

FIG. 21 is a side elevation showing a window opening formed through the side wall panel of the enclosure illustrated in FIG. 2;

FIG. 22 is a vertical cross-section of the window opening shown in FIG. 21; and

FIG. 23 is a horizontal cross-section of the window opening shown in FIG. 21.

### DETAILED DESCRIPTION

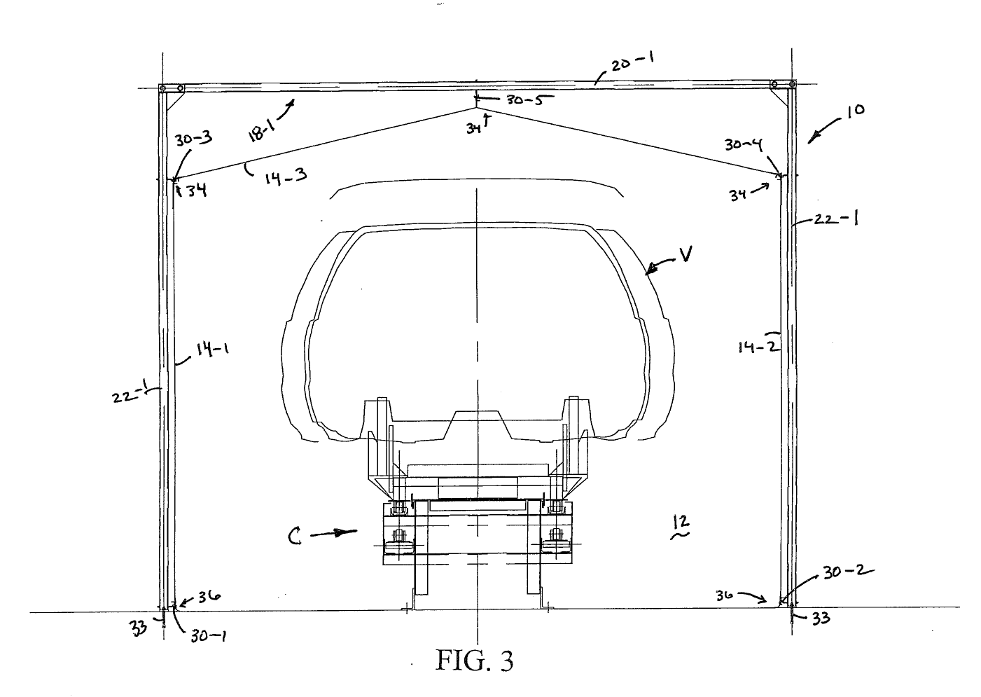

The following description is merely exemplary in nature and is not intended to limit the present disclosure, application, or uses. It should be understood that throughout the drawings corresponding reference numerals indicate like or corresponding parts and features. As may be seen in FIGS. 1-3, an environmentally controlled enclosure system 10 is illustrated. The environmentally controlled enclosure system 10 prevents contaminants from entering an interior volume 12 (see FIG. 3). In one application the enclosure 10 is erected in an automobile manufacturing plant where a vehicle V travels therethrough from one location to another along a carriage or conveyor C. While the figures illustrate an enclosure 10 configured for a vehicle body, it can be configured for other assemblies, sub-assemblies or parts. Furthermore, one skilled in the art will understand that the enclosure 10 may be used in a variety of different manufacturing environments and is not limited to use in an automotive assembly plant. Environmentally controlled enclosure system 10 includes a sheeting assembly having a pair of side wall portions 14-1, 14-2 and a roof portion 14-3 (collectively referred to as panels 14) that are suspended within a frame structure 16 to define the interior volume 12. The sheeting assembly may include multiple sheets arranged in an end-to-end relationship to provide the necessary length for the enclosure 10. When arranged in this manner hook and loop fasteners such as Velcro® provide a preferred means for interconnecting adjacent sheet. However, one skilled in the art will understand that other suitable means may be employed. These suitable means include snaps, screws, rivets, tape, sewing, adhesive, welding, etc.

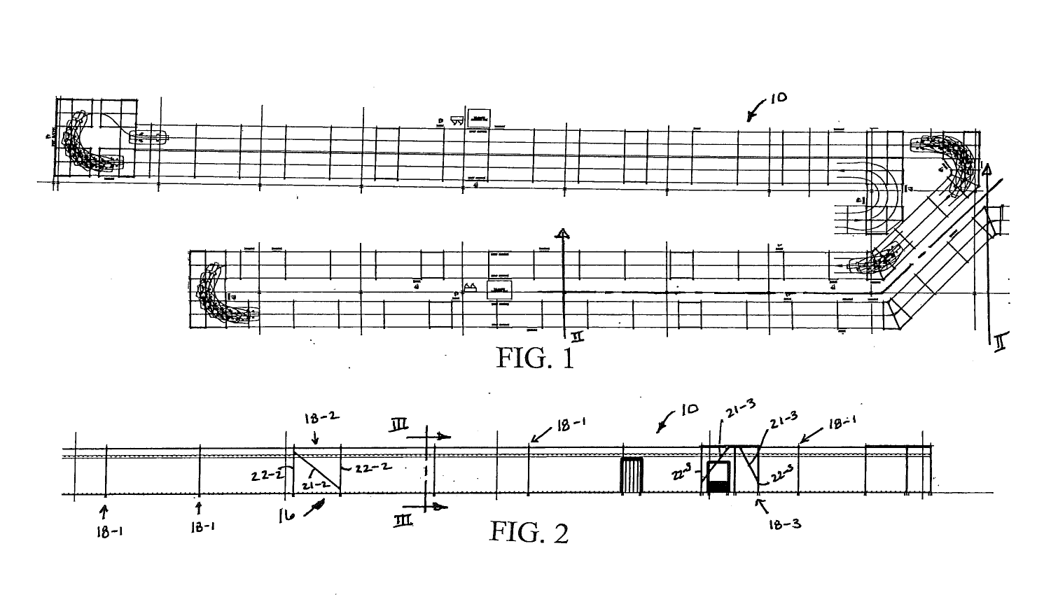

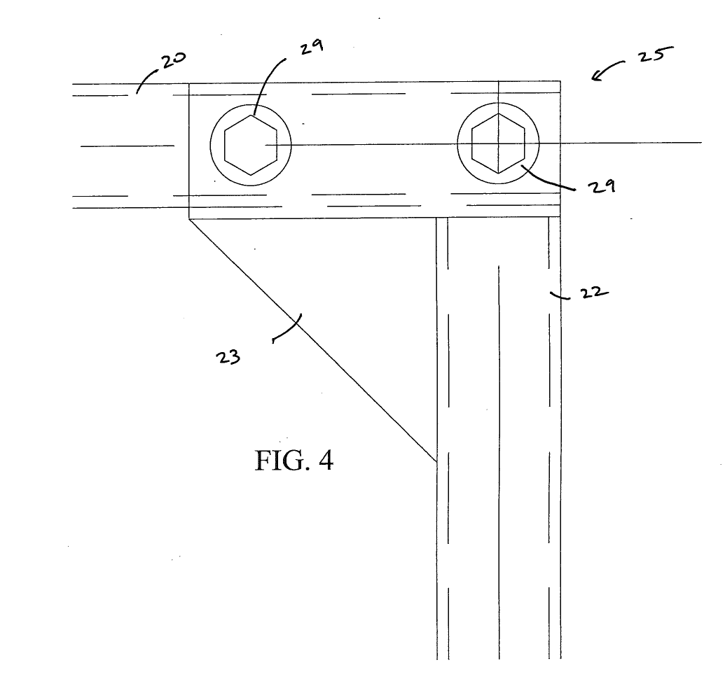

Referring to FIGS. 2-8, environmentally controlled enclosure 10 is formed by a frame structure 16 composed of a plurality of free standing frame members 18, each having a truss member 20 and legs 22 that support truss 20. Although a majority of the frame members 18-1 include a single truss 20-1 supported by a pair of legs 22-1 as illustrated, it should be understood that the frame members may be formed by a plurality of trusses supported by a plurality of legs. For example, FIG. 2 illustrates a plurality of single frame members 18-1 located between anchoring stations 18-2 and 18-3.

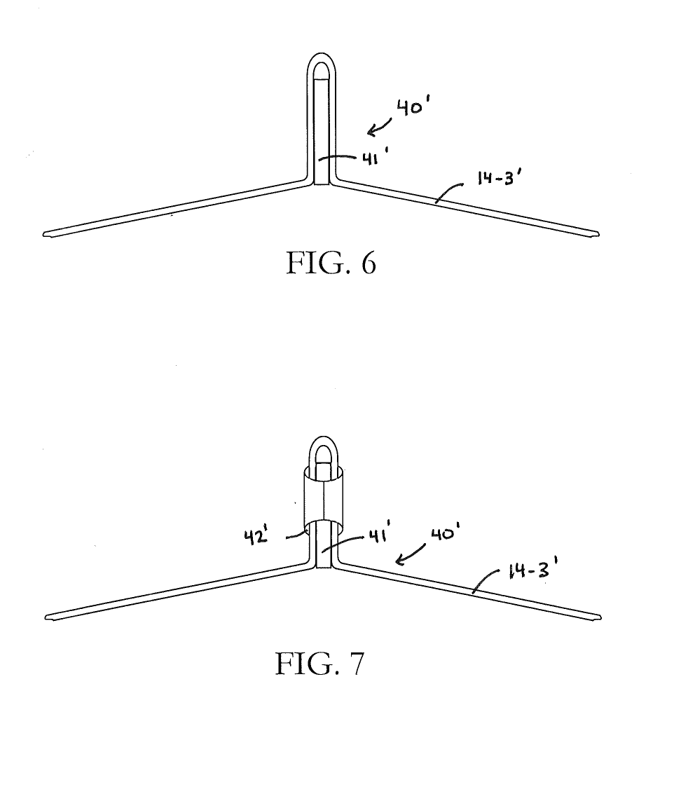

As best seen in FIG. 2, anchoring station 18-2 includes a diagonal member 21-2 extending between a set of closely spaced legs 22-2 to enhance the rigidity of the anchor station 18-2 and prevent match-boxing of the structure. Likewise anchor station 18-3 includes a pair of diagonal members 21-3 extending between legs 22-3. As can be seen in FIG. 1, anchoring station 18-3 is also configured to provide a 45° turn (in the plan view) of the enclosure system 10. Truss 20 and legs 22 are preferably formed of a standard thin-walled steel square tubing or some other suitable material that provides sufficient rigidity and strength to frame system 18. With reference to FIG. 7, truss 20 is secured to leg 22 by a gusset plate 23 at joint 25 between truss 20 and legs 22 by a weld 27 or other suitable fastening means. For example, truss 20 and legs 22 may be secured together via fasteners 29, which may be screws, rivets, staking, adhesive or any other type of fastener suitable to secure truss 20 to legs 22 as is known in the art. As best seen in FIGS. 3 and 6, legs 22 are secured to the floor 31 via a fastener 33.

Referring again to FIGS. 1-3, a cable system 28 extends along the length of enclosure 10 and interconnects frame members 18-1, 18-2, 18-3. In particular, anchoring stations 18-2, 18-3 are situated at each end of a cable system 28. The additional structure and rigidity of the anchoring stations 18-2, 18-3 function as pulling points for adequately tensioning the cable system 28. Once in place, the cable system 28 is used to suspend and anchor plastic panels 14. Cable system 28 includes a plurality of cables 30-1 through 30-5 (referenced collectively as cables 30) that are supported by a plurality of suspension mechanisms 34 and anchoring mechanisms 36. Cables 30 are formed from a flexible wire rope, for example, and may have a protective coating. As presently preferred, suspension mechanisms 34 and anchoring mechanisms 36 are in the form of an eye bolt (i.e., a bolt having an eye portion 35 extend at least 270°) that is secured to either truss 20 or legs 22.

Other anchoring mechanisms such as a hook that extends less than 270° may be used but are less preferred. Suspension mechanisms 34 and anchoring mechanisms 36 have a threaded portion 37 that passes through truss 20 or leg 22 and are secured thereto by a nut 38 that allows suspension mechanisms 34 and anchoring mechanisms 36 to be adjusted. In this manner, by adjusting suspension mechanisms 34 and anchoring mechanisms 36, a tension of cables 30 between suspension mechanisms 34 and anchoring mechanisms may be adjusted. The cable system may further include a turn buckle (not shown) on an end thereof to allow further adjustment of the cable tension. Moreover, by adjusting a tension of cables 30, the tension of curtain 26 may be adjusted as well.

A sheeting assembly 24 which includes panels 14-1, 14-2 and 14-3 is suspended from trusses 20 and anchored to legs 22 to form a plastic curtain 26. Panels 14 are preferably formed of a plastic sheeting which overlap at the edges to form curtain 26, and provides an interior volume 12 of enclosure system 10 with a controlled environment. Curtain 26 provides a controlled environment that assists in preventing contaminates from reaching vehicle 14 as vehicle 14 is moved from station to station within manufacturing plant.

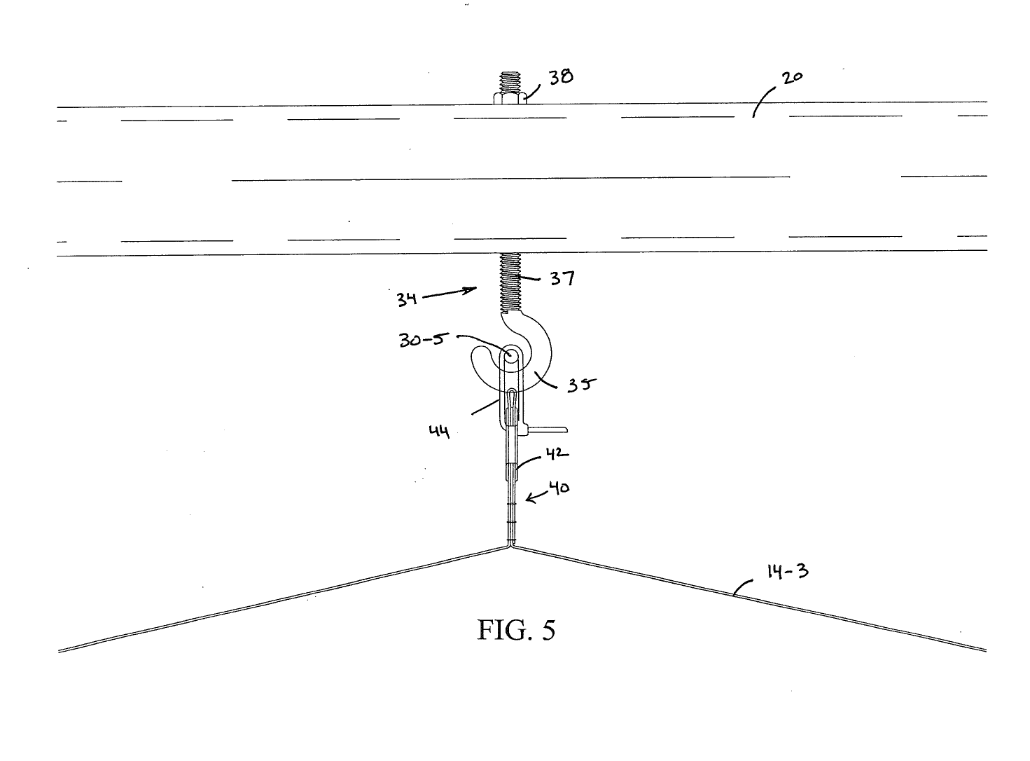

With reference now to FIG. 5, the details for interconnecting the roof panel 14-3 to the truss 20 is illustrated. Specifically, the suspension mechanism 34 is secured to truss 20 and extends downwardly towards the floor of the enclosure 10. Roof panel 14-3 has a hem 40 formed therein. A series of grommets 42 extend through the hem 40 to provide a reinforced opening in the roof panel 14-3. Grommets 42 are placed in the hem along the entire length of the sheeting to provide multiple attachment points. The hem 40 may be formed using conventional means such as a triple sewn hem which may be reinforced with additional sheet material. Alternately, as shown in FIGS. 5 and 6, the hem 40′ may be formed in roof panel 14-3′ with a double-sided fabric tape 41′ securing the hem portions together. In this alternate configuration, the hem 40′ may be further sewn to provide additional integrity and strength. A grommet 42′ extends through the reinforcement hem 40′.

Referring again to FIG. 5, it will be appreciated that each of the frame members 18 along the enclosure 10 includes a suspension mechanism 34 extending from truss 20. A central roof cable 30-5 extends through the eye portion suspension mechanism 34. The roof panel 14-3 is then secured to the central roof cable 30-5 by a series of cable ties 44. In particular, each cable tie 44 is passed through the hole of grommet 42 and around cable 30-5. Once so positioned, the cable tie is fastened to secure the hem portion 40 of room panel 14-3 to the roof cable 30-5.

Turning now to FIG. 6, the details of the upper anchoring point for the side wall panel 14-2 and the roof panel 14-3 are illustrated. The anchoring mechanism 36 is secured to the leg member 22-1. Cable 30-4 extends through the eye portion of anchoring mechanisms 36. A hem 46 formed along the lateral edge of roof panel 14-3 has a series of grommets 48 extending therethrough. In this manner, the hem 46 is formed in substantially the same way as hem 40 previously described. Cable ties 50 secure the lateral edge of roof panel 14-3 to cable 30-4. A skirt 52 is attached to hem 46 along the lateral edge of roof panel 14-3. The skirt 52 extends over cable 30-2 to overlap with the upper portion of side wall 14-2. In this way, the skirt 52 functions to provide additional sealing at the interface between the side wall panel 14-2 and the roof panel 14-3. The side wall 14-2 includes a hem 54 having a series of grommets 56 formed therethrough. Cable ties 58 extend through grommet 56 and around cable 30-4 to secure the side wall panel 14-2 thereto.

Turning now to FIG. 7, the details of the lower anchoring point between side wall 14-2 and leg 22-1 are illustrated. In particular, anchoring mechanism 36 is secured at a lower end leg 22-1. Cable 30-2 extends through the eye portion 35 of anchoring mechanism 36. A hem 60 is formed on the lower edge of side wall panel 14-2 in a manner similar to hem 40 previously described. A series of grommets 62 extend through hem 60. Cable ties 64 are inserted through grommets 62 and around cable 30-2 for securing side wall panel 14-2 thereto. A skirt 66 is further secured to hem 60 and extends downwardly to the floor F. The length of skirt 66 is such that its lower edge is allowed to wipe along floor F, thereby providing additional sealing for the interior volume 12 of enclosure 10.

The use of a cable system 28 to suspend curtain 26 within the frame structure 16 reduces the cost to fabricate environmentally controlled enclosure. In this regard, rather than producing a frame structure 16 substantially formed of rigid u-channel member or struts, the cable system 28 requires a minimal frame structure formed to support panels 14. A reduction in the use of rigid members for enclosures 10 reduces the overall cost to manufacture. Moreover, the cable system 28 is relatively simple in design, which reduces the time to manufacture and set up enclosure system 10.

While, curtain 26 is shown as being formed of plastic sheeting, one skilled in the art will recognize that semi-rigid panels may also be used in the fabrication of enclosure 10. As such the term sheeting assembly is indeed to encompass any type of flexible or semi-rigid materials used for the fabrication of the enclosure 10. In either embodiment, it is preferred to use a plastic that does not burn, but rather melts if subjected to an abnormally high temperature. Because curtain 26 may melt rather than burn, no hazardous or noxious fumes may be released. Such a feature enables the omission of sprinklers within enclosure system 10, which also reduces the cost to manufacture, maintain, and erect enclosure system 10.

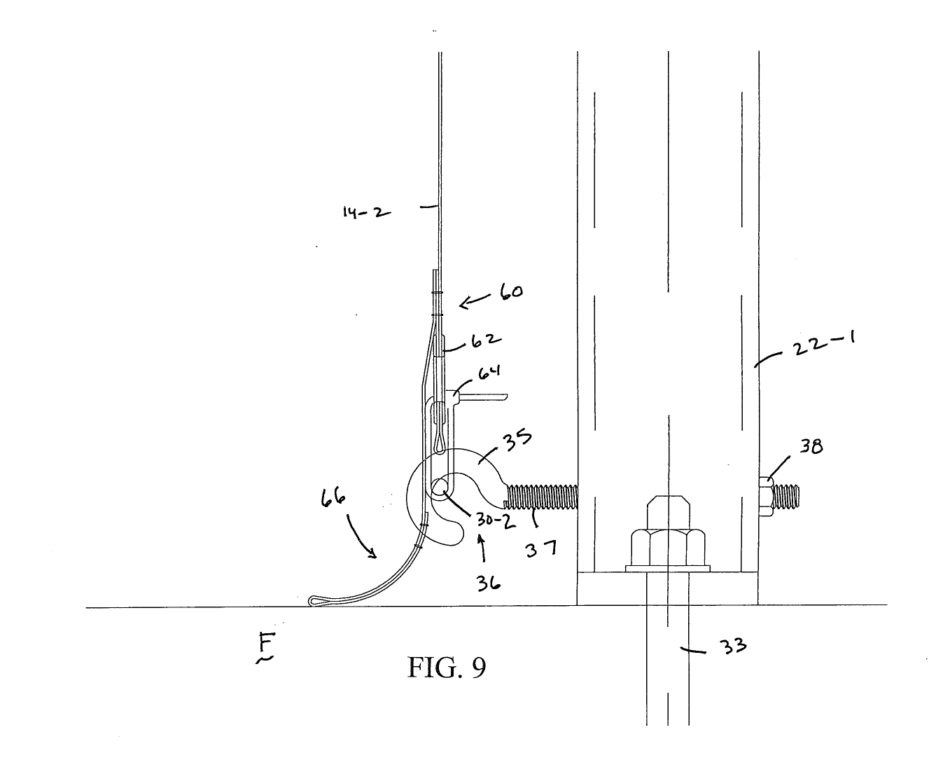

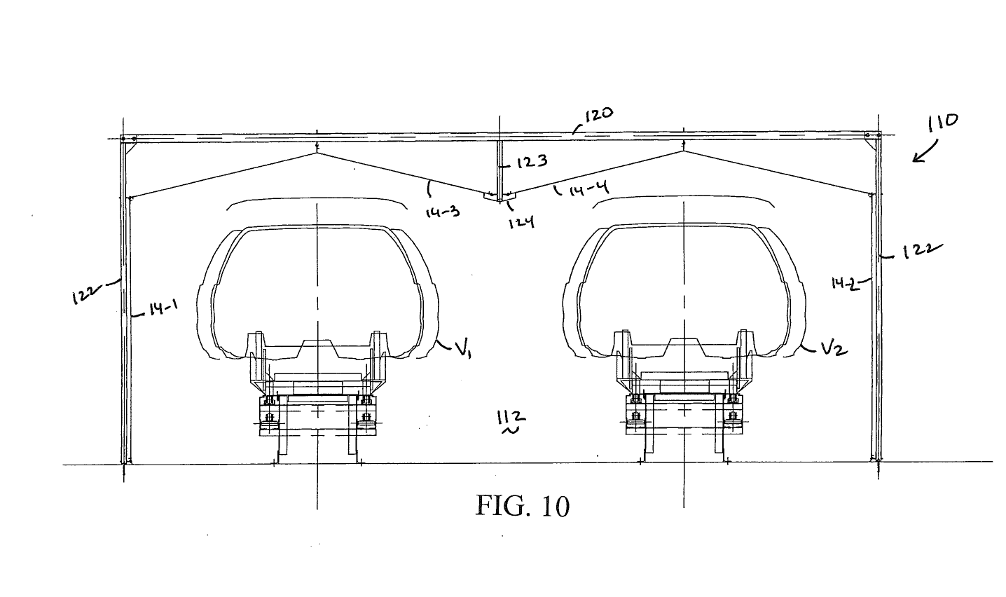

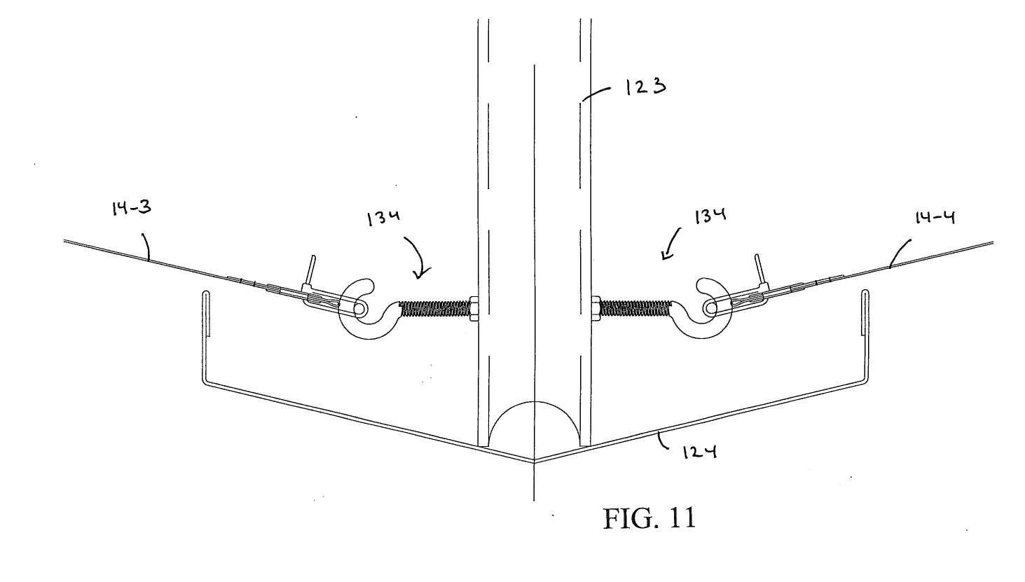

Although enclosure 10 illustrated in FIGS. 3-9 is able to accommodate a single vehicle V passing therethrough, the present disclosure is not limited thereto. In this regard, now referring to FIGS. 10 and 11, enclosure system 110 may be formed of a frame structure 116. Similar to frame structure 16, frame structure 116 may be formed by a plurality of free standing frame members 118, each having a truss 120 and legs 122 that support truss 120. Truss 120 may have a length sufficient to accommodate a pair of vehicles V₁,V₂, or more.

With specific reference now to FIG. 11, a drop member 123 extends downward from truss 120. Suspension members 134 extend on either side of drop member 123 to secure cables 130-5, 130-6 thereto. In this manner, a pair of roof panels 14-3, 14-4 may be supported by frame structure 116, without sacrificing the environmentally controlled environment within the interior volume 112. A drip pan or gutter 124 is formed as a shallow V-shaped channel. The gutter 124 extends along the length of enclosure 110 and is secured to the drop members 123 on each frame member 118 below suspension members 134. In this way, gutter 124 functions to seal the gap between roof panels 14-3 and 14-4. The gutter 124 further functions to collect moisture and debris which may fall on top of roof panels 14-3, 14-4 and carry it away from enclosure 110.

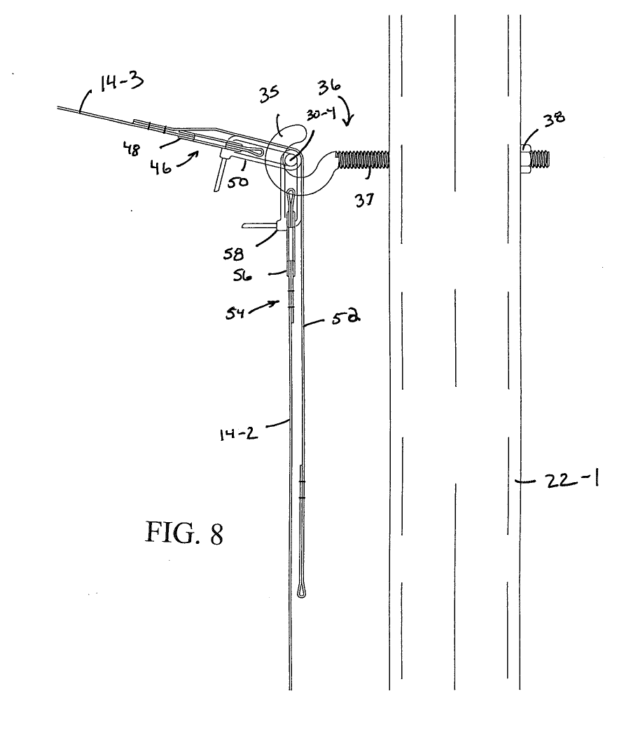

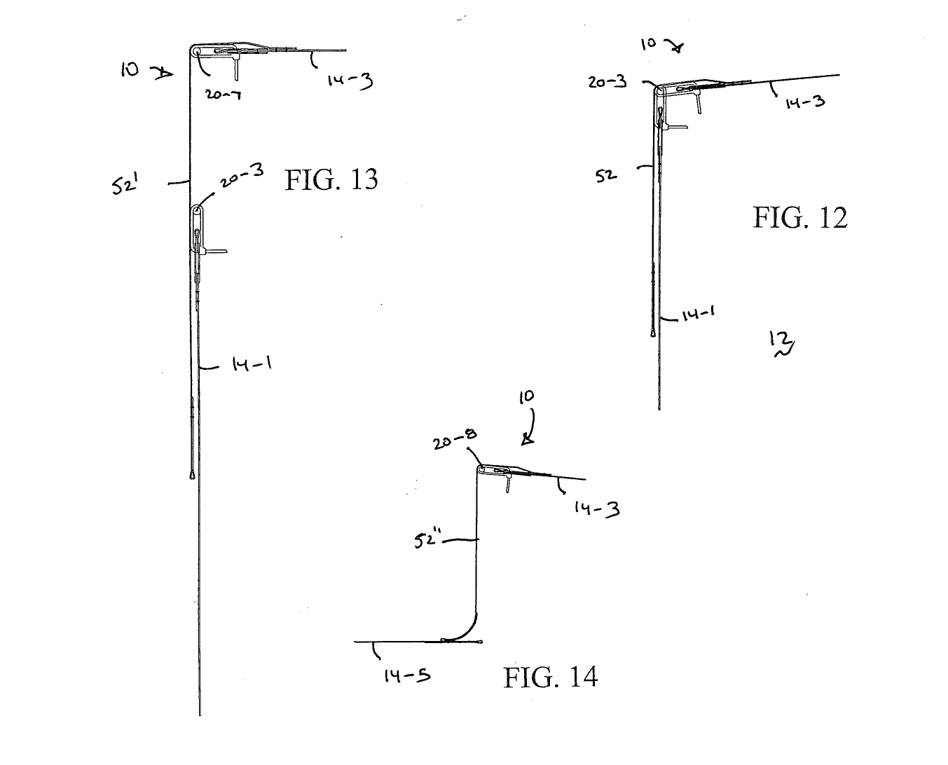

Referring now to FIG. 12, the interconnection between side wall panel 14-1 and roof panel 14-3 is illustrated. Specifically, side wall panel 14-1 is secured along an upper edge to support cable 20-3 in a manner similar to that described with respect to side wall 14-2 in FIG. 8. Likewise, roof panel 14-3 is secured to upper support cable 20-3 in a manner similar to that described in reference to FIG. 8. A skirt 52 extends from roof panel 14-3 down along side wall panel 14-1 to further improve sealing of the interior volume 12.

With reference now to FIG. 13, an alternate configuration of enclosure 10 is illustrated in which side wall panel 14-1 is supported on cable 20-3 and roof panel 14-3 is supported on a separate, independent cable 20-7. One skilled in the art will recognize that support cables 20-3 and 20-7 are secured to frame members 18 in the manner similar to that described herein. In this configuration, the skirt 52′ extends downward further then as previously illustrated with reference to skirt 52 such that the gap between side wall panel 14-1 and roof panel 14-3 is adequately traversed.

With reference now to FIG. 14, another alternate configuration of the enclosure 10 is illustrated. In this configuration, roof panel 14-3 is configured to transition to an adjacent horizontal surface 14-5. Horizontal surface 14-5 may be an adjacent roof panel which is lower than roof panel 14-3 or further existing structure which is placed in sealed relationship to the enclosure 10. Support cable 20-8 extends along enclosure 10 in a manner similarly described heretofore. Roof panel 14-3 is secured to cable 20-8. A skirt 52″ extends over support cable 20-8 and is allowed to drape downward onto adjacent horizontal surface 14-5. The length of skirt 52″ is sufficiently long such that the bottom edge is placed in sealing relationship to surface 14-5.

One skilled in the art will understand that enclosure 10 may be readily joined to other adjacent structures. To this end the sheet assembly includes additional panels sized and shaped to traverse an opening forward between enclosure 10 and the adjacent structure. These additional panels may be secured to the cable system 28 using cable ties as previously described. The additional panels may also be secured to the frame structure 16 using hook and loop fasteners, snaps, screws, rivets, tape or adhesives. Alternatively, an interface frame of a design similar to that described in the patents referenced in the background may be constructed for securing the additional panels in place.

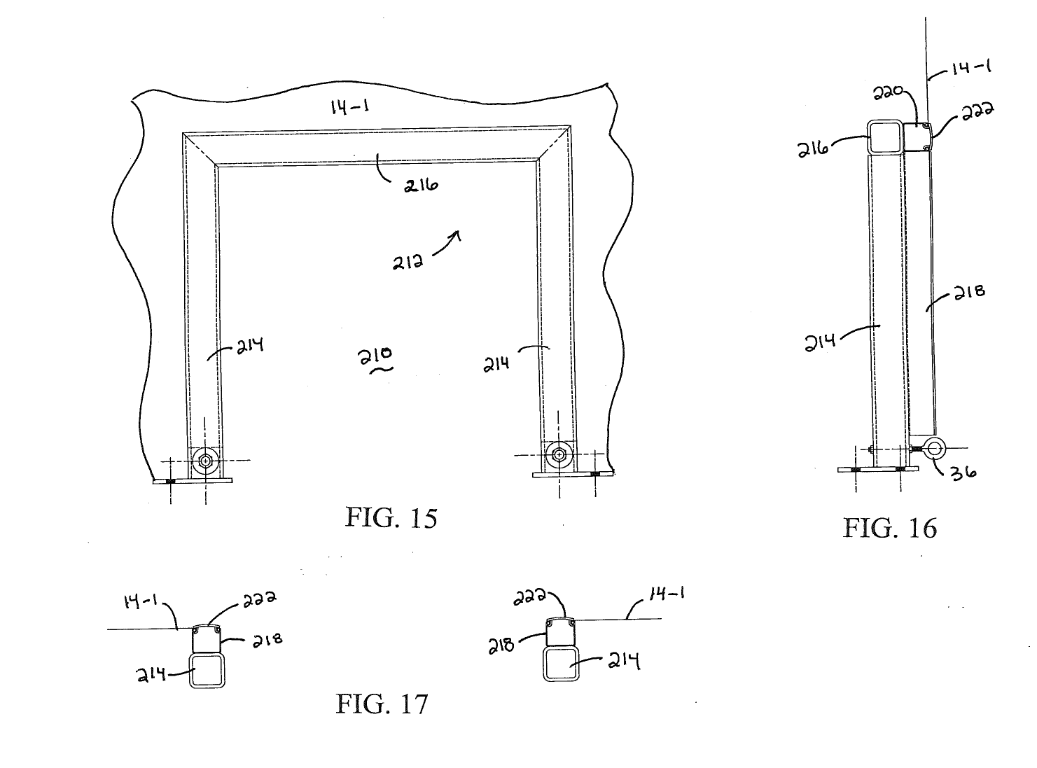

As described herein, the enclosure 10 provides a sealed environment in which certain manufacturing processes may be carried out. While the sealed enclosure 10 isolates the interior volume 12 from the surrounding environments, it is desirable to provide access to the interior 12 of the enclosure 10. In particular, access must be provided for allowing conveyor drives, hydraulic or pneumatic lines, electrical power lines and other utilities into the enclosure 10. It may be necessary to provide an access opening 210 in side panel 14-1 and/or 14-2. With reference now to FIGS. 15-17, an access frame 212 includes a pair of legs 214 and a cross member 216. The legs 214 may be secured to the floor with threaded fasteners in a manner similar to that described with reference to legs 22. The side wall panel 14-1 is secured to the access frame 212 using any conventional means including an adhesive, threaded fasteners or hook and loop fasteners such as Velcro®. Alternatively, the access frame 212 may include a pair of vertical attachment channels 218 and a horizontal attachment channel 220. These attachment channels 218, 220 are secured to access frame 212. The side wall panel 14-1 is positioned within the u-shaped channel and a cap 222 secured over the opening of the u-shaped channel. In this way, the access frame 212 may be readily attached and detached from the side wall panel to provide an access opening into the enclosure 10.

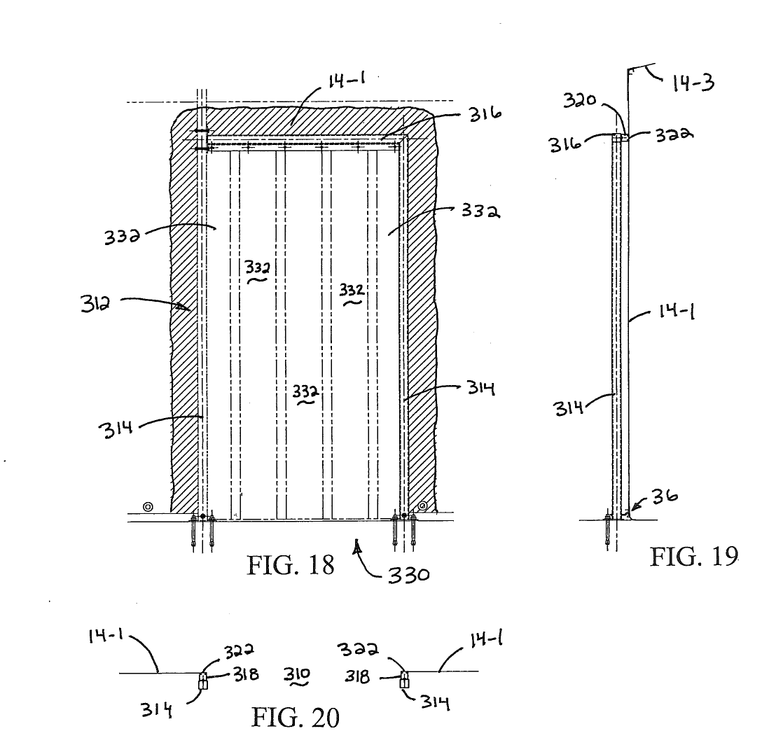

With reference to FIGS. 18-20, it may also be desirable to provide a doorway 310 within the side wall panel 14-1. For example, a door curtain 330 may be placed within a side wall panel 14-1 to provide access to the enclosure 10. As presently preferred, a door curtain 330 includes a number of plastic strips 332 or other such material suitable for a manufacturing environment. The curtain 330 is supported by a door frame 312. Door frame 312, like access frame 212 includes a pair of legs 314 and a cross member 316. The door frame 312 further includes a pair of vertical u-channels 318 and a horizontal u-channel 320 for securing the side wall panel 14-1 thereto. Cap 322 is secured over u-channels 318, 320 in a manner similar to that described with respect to the access opening 210. As best seen in FIG. 18, the threshold 334 of the doorway is clear to allow easy access into the enclosure. To this end, an anchoring mechanism 36 is placed at the lower end of the vertical door frame members 312 and the adjacent cables 30-1 terminate at the legs 312, leaving the threshold free of obstructions. Alternately a step-over threshold (not shown) could be placed over cables extending across the door opening 310.

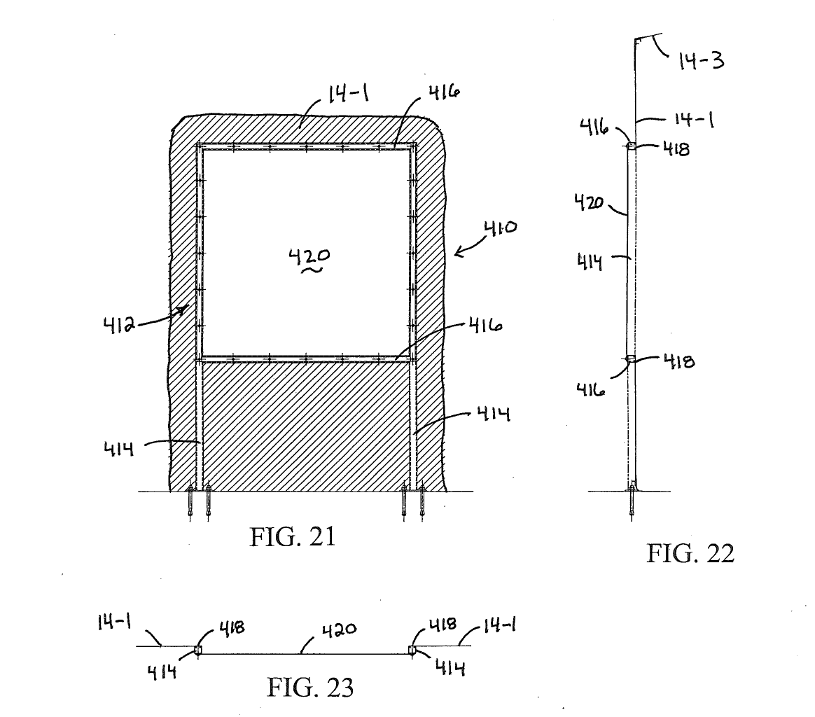

With reference now to FIGS. 21-23, the enclosure 10 may further be provided with a window opening to permit visual inspection along the enclosure without requiring access to the interior volume. The window opening 410 is formed in a manner similar to that described with reference to the door opening 310 and the access opening 210. The window opening 410 includes a window frame 412 formed of a pair legs 414 and a pair of crossbars 416. While the window frame 412 may be formed from a structure similar to that described with respect to door opening 310 and access opening 210, the structural requirements of the window opening do not necessitate the use of frame members. Instead, the window frame 412 may be fabricated from the u-shaped channel similar to channels 218, 220 described in reference to the access opening 210. Caps 418, likes caps 222 secure the side wall panel 14-1 to the frame members 414, 416.

A windowpane 420 is placed on the window frame 412 on a side opposite the caps 418. In this manner, the windowpane 420 is secured over the opening defined between legs 414 and crossbars 416. The windowpane 420 may be secured to the window frame 412 by any suitable means including threaded fasteners, adhesives or Velcro®.

The enclosure 10 and the various alternate configurations described above demonstrate the flexibility with which a sealed enclosure may be assembled and installed within a manufacturing environment. To this end, it may be required to marry the enclosure 10 to other existing structure including additional enclosures or more permanent housing or control rooms. The present invention has the advantage of being sufficiently flexible in design to accommodate and address this requirement. Moreover, the ease and flexibility with which this present system may be fabricated and assembled affords additional opportunities to enclose assembly lines and conveyor systems having complex geometries.

The above description is merely exemplary in nature and, thus, variations that do not depart from the gist of the present disclosure are intended to be within the scope of the present disclosure. Such variations are not to be regarded as a departure from the spirit and scope of the present disclosure.

What is claimed is:

1. An environmentally controlled enclosure comprising:
a structure having a plurality of frame members sequentially arranged in a first direction, each frame member including first and second legs and a truss extending therebetween;
a cable system supported by the plurality of frame members, the cable system including at least one cable extending between the plurality of frame members in the first direction; and
a sheeting assembly suspended within the structure and secured to the cable system, the sheeting assembly defining an interior volume with a first side wall portion extending along the first legs, a second side wall portion extending along the second legs and a roof portion extending along the trusses.

2. The environmentally controlled enclosure of claim 1 wherein the cable system further comprises:
a first cable supported from the truss of each of the plurality of frame members, the roof portion of the sheeting assembly being secured to the first cable;
a second cable supported from the first leg of each of the plurality of frame members at an end opposite the truss, the first side wall portion of the sheeting assembly being secured to second cable; and
a third cable supported from the second leg of each of the plurality of frame members at an end opposite the truss, the second side wall portion of the sheeting assembly being secured to the third cable.

3. The environmentally controlled enclosure of claim 2 wherein the cable system further comprises:
a fourth cable supported from the first leg of each of the plurality of frame members at an end adjacent to the trusses, the first side wall portion of the sheeting assembly being secured to the fourth cable; and
a fifth cable supported from the second leg of each of the plurality of frame members at an end adjacent to the trusses, the second side wall portion of the sheeting assembly being secured to the fifth cable.

4. The environmentally controlled enclosure of claim 1 wherein the sheeting assembly comprises a three-panel assembly including a roof panel, a first side wall panel and a second side wall panel.

5. The environmentally controlled enclosure of claim 4 wherein the roof panel further comprises a first skirt extending from a first lateral edge of the roof panel and overlapping an adjacent edge of the first side wall panel, and a second skirt extending from a second lateral edge of the roof panel and overlapping an adjacent edge of the second side wall panel.

6. The environmentally controlled enclosure of claim 4 further comprising a first skirt extending from an edge of the first side wall panel opposite the roof panel and a second skirt extending from an edge of the second side wall panel opposite the roof panel.

7. The environmentally controlled enclosure of claim 1 wherein the at least one cable comprises a roof cable suspended from the trusses of each of the plurality of frame members and the roof portion of the sheeting assembly further comprises a hem secured to the roof cable.

8. The environmentally controlled enclosure of claim 7 further comprising a series of grommets extending through the hem for securing the roof portion to the roof cable.

9. The environmentally controlled enclosure of claim 1 wherein the structure further comprises an anchoring station located at each end of the cable system and the plurality of frame member being position between the anchoring stations.

10. The environmentally controlled enclosure of claim 9 wherein each anchoring station comprises a pair of the plurality of frame members and a diagonal brace extending therebetween.

11. The environmentally controlled enclosure of claim 1 further comprising an access frame, wherein the first side wall portion is secured to the access frame such that an access opening is defined therethrough.

12. The environmentally controlled enclosure of claim 1 further comprising;
a door frame, wherein the first side wall portion is secured to the door frame such that a doorway is defined therethrough; and
a curtain suspended from the door frame in the doorway.

13. The environmentally controlled enclosure of claim 1 further comprising;
a window frame, wherein the first side wall portion is secured to the window frame such that a window opening is defined therethrough; and
a windowpane secured to the window frame to cover the window opening.

14. An environmentally controlled enclosure comprising:
a structure having a plurality of frame members including a first end member, a second end member and a plurality of intermediate members sequentially arranged in a first direction between the first and second frame members, each of the plurality of frame members including first and second legs and a truss extending therebetween;
a cable system having a first end secured to the first end member and a second end secured to the second end member, the cable system including a first cable supported from the truss of each of the plurality of frame members, a second cable supported from the first leg of each of the plurality of frame members at an end opposite the truss, and a third cable supported from the second leg of each of the plurality of frame members at an end opposite the truss; and
a sheeting assembly suspended within the structure and secured to the cable system, the sheeting assembly defining an interior volume with a roof portion secured to the first cable, a first side wall portion secured to the second cable and a second side wall portion secured to the third cable.

15. The environmentally controlled enclosure of claim 14 wherein the sheeting assembly comprises a three-panel assembly including a roof panel, a first side wall panel and a second side wall panel.

16. The environmentally controlled enclosure of claim 15 wherein the cable system further comprises:
a fourth cable supported from the first leg of each of the plurality of frame members at an end adjacent to the truss, the first side wall portion of the sheeting assembly being secured to the fourth cable; and
a fifth cable supported from the second leg of each of the plurality of frame members at an end adjacent to the truss, the second side wall portion of the sheeting assembly being secured to the fifth cable.

17. The environmentally controlled enclosure of claim 15 wherein the roof panel further comprises a first skirt extending from a first lateral edge of the roof panel and overlapping an adjacent edge of the first side wall panel, and a second skirt extending from a second lateral edge of the roof panel and overlapping an adjacent edge of the second side wall panel.

18. A method of assembling an environmentally controlled enclosure comprising:
assembling a structure having a plurality of frame members including a first end member, a second end member and a plurality of intermediate members sequentially arranged in a first direction between the first and second end members, each of the plurality of frame members including first and second legs and a truss extending therebetween;
securing a first cable to the trusses on each of the first and second end members and supporting the first cable from the truss of each of the plurality of intermediate members;
securing a second cable to the first legs on each of the first and second end members and supporting the second cable from the first leg of each of the plurality of intermediate frame members;
securing a third cable to the second legs on each of the first and second end members and supporting the third cable from the second leg of each of the plurality of intermediate members; and
securing a roof portion of a sheeting assembly to the first cable, a first side wall portion of the sheeting assembly to the second cable and a second side wall portion of the sheeting assembly to the third cable such that the sheeting assembly is suspended within the structure and defines an interior volume.

19. The method of assembling an environmentally controlled enclosure of claim 18 further comprising:
securing a fourth cable to the first legs on each of the first and second end members and supporting the fourth cable from the first leg of each of the plurality of intermediate members;
securing a fifth cable to the second legs on each of the first and second end members and supporting the fifth cable from the second leg of each of the plurality of intermediate members; and
securing the first side wall portion to the fourth cable and the second side wall portion to the fifth cable.

20. The method of assembling an environmentally controlled enclosure of claim 18 further comprising:
forming a hem in the roof portion of the sheeting assembly; and
suspending the sheeting assembly within the frame structure by securing the hem to first cable before securing the first side wall panel to the second cable and securing the second side wall panel to the third cable.
